(19) United States
(12) Patent Application Publication
(10) Pub. No.: US 2024/0062633 A1
(43) Pub. Date: Feb. 22, 2024

(54) METHOD OF INTERCONNECTING TELLER COMPUTING DEVICE WITH PERIPHERALS IN A BANK BRANCH

(71) Applicant: Diebold Nixdorf, Incorporated, North Canton, OH (US)

(72) Inventors: Achim Wehling, Paderborn (DE); Markus Nuebel, Lippstadt (DE)

(21) Appl. No.: 18/270,379

(22) PCT Filed: Dec. 28, 2021
(86) PCT No.: PCT/US2021/065314

§ 371 Date: Jun. 29, 2023

Related U.S. Application Data
(60) Provisional application No. 63/131,833, filed on Dec. 30, 2020.

(51) Int. Cl. G07F 19/00

(52) U.S. Cl. CPC G07F 19/211; G07F 19/201

(57) ABSTRACT

A method of interconnecting, within a bank branch, a teller-utilized computing device with peripherals includes placing the computing device and the peripherals in communication with a branch server. The branch server can operate a RESTful Services Interface to communicate with the computing device through a browser. The RESTful Services Interface can call a peripheral interface that defines an abstraction layer that is independent of a J/XFS implemented device layer in response to receiving a request for service. The peripheral interface can call a peripheral instance and a peripheral implementation that includes a command to perform the service. The method also includes communicating, from the peripheral interface, the peripheral implementation to the one of the plurality of peripherals. The method also includes performing, with the one of the plurality of peripherals, the requested service.

### CROSS-REFERENCE TO RELATED APPLICATIONS

This application claims the benefit of U.S. Provisional Patent Application Ser. No. 63/131,833 for a METHOD OF INTERCONNECTING TELLER COMPUTING DEVICE WITH PERIPHERALS IN A BANK BRANCH, filed on Dec. 30, 2020, which is hereby incorporated by reference in its entirety.

### BACKGROUND

### 1. Field

The present disclosure relates to interconnecting, within a bank branch, a teller-utilized computing device with a plurality of peripherals.

### 2. Description of Related Prior Art

U.S. Pat. No. 6,886,170 discloses a method and apparatus in a data processing system for the issuance and delivery of lightweight requests to concurrent and multiple service providers. A request event is received at a transporter object. The request event includes a target and an indication of how to handle the request event. A destination object is identified within the plurality of destination objects using the request event to form an identified destination object. The request event is sent to the identified destination object, wherein the identified destination object handles the request using the indication and accesses the target.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of interconnecting, within a bank branch, a teller-utilized computing device with a plurality of peripherals includes placing the teller-utilized computing device in communication with a branch server of the bank branch. The method also includes placing each of the plurality of peripherals in communication with the branch server of the bank branch. The method also includes operating, on the branch server, a RESTful Services Interface. The method also includes communicating, by the teller-utilized computing device, a request for service from one of the plurality of peripherals to the RESTful Services Interface through a browser operating on the teller-utilized computing device. The method also includes calling, with the RESTful Services Interface, a peripheral interface in response to receiving the request for service. The peripheral interface defines an abstraction layer that is independent of J/XFS. The request for service is communicated to the peripheral interface during said calling. The method also includes calling, with the peripheral interface, a peripheral instance corresponding to the one of the plurality of peripherals and a peripheral implementation corresponding to the peripheral instance. The peripheral implementation can include a command to perform the service requested during said communicating. The method also includes communicating, from the peripheral interface, the peripheral implementation to the one of the plurality of peripherals. The method also includes performing, with the one of the plurality of peripherals, the requested service.

### BRIEF DESCRIPTION OF THE DRAWINGS

The detailed description set forth below references the following drawings:

FIG. 1 is a functional block diagram of a portion of a banking computing system according to an exemplary embodiment of the present disclosure;

FIG. 2 is a functional block diagram of a sub-portion of the content of FIG. 1;

FIG. 3 is a functional block diagram of a sub-portion of the content of FIG. 2;

FIG. 4a is coding of an exemplary device system initializer according to an exemplary embodiment of the present disclosure;

FIG. 4b is coding of an exemplary device instance manager according to an exemplary embodiment of the present disclosure;

FIG. 4c is coding of an exemplary device implementation according to an exemplary embodiment of the present disclosure;

FIG. 5 is a simplified flow diagram of a process that can be performed by one or more embodiments of the present disclosure;

FIG. 6a is coding of an exemplary web service class declaration according to an exemplary embodiment of the present disclosure; and

FIG. 6b is coding of an exemplary web service implementation according to an exemplary embodiment of the present disclosure.

### DETAILED DESCRIPTION

The present disclosure, as demonstrated by the exemplary embodiment described below, can provide a RESTful Services Interface which allows to access to peripherals in a bank branch via http/https. The RESTful Services Interface defines a much higher level of abstraction than a J/XFS interface. Also, this makes the implementation of new peripherals, which are accessed in a Web App, much easier.

J/XFS is a Java based version of the CEN/XFS (extensions for financial services) specification. It abstracts the layer of communication with a peripheral device by defining an industry agreed set of methods. But in order to allow customers to do their own peripheral implementation, the interconnection between the teller computing devices and peripherals in the bank branch must be independent of a J/XFS implementation. In the exemplary embodiment of the present disclosure, the RESTful Services Interface for services does not call a J/XFS implementation directly. Rather, the RESTful Services Interface calls a device/module defining an abstraction layer. The exemplary module is called FOPeripheral herein. The FOPeripheral is independent from a J/XFS implementation. Customer specific implementations can thus be easily plugged in and replaced as the customer desires.

The exemplary arrangement disclosed herein provides a web developer with an interface for accessing peripherals which is particularly easy to modify. Further, FOPeripheral is a plugin system witch doesn't rely on J/XFS. The exemplary arrangement decouples the Web Application (the RESTful Services Interface) and the web services (FOPeripheral) from the peripheral implementation. That means that if a customer choose to introduce a new peripheral at the bank branch, the Web App and the Web Services can stay as they are; no change are required of them as long as the REST interface and the FODevice layer (described below) already have an interface definition for the new peripheral. In case they don't, both definitions have to be added and implementations have to be made accordingly.

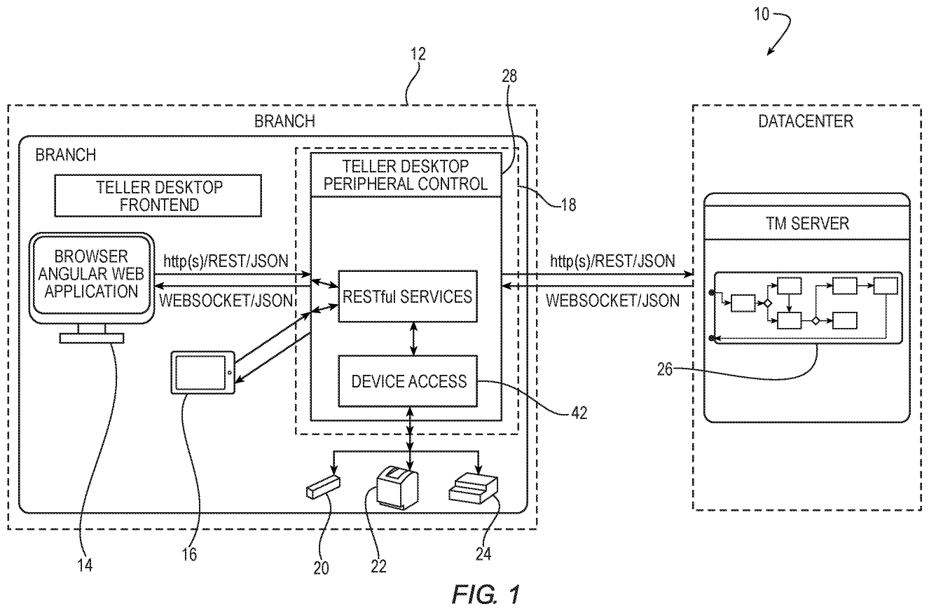

Referring now to FIG. 1, a portion of a banking computing system includes a data center 10. The data center 10 can define/include a core banking computing system. The data center 10 can also define/include one or more switches communicating with the core. The core and switches are computing devices each having one or more processors and can communicate with one another over one or more private networks, one or more public networks, or a combination of at least one private network and at least one public network. Communications between the core and switches are usually secured and can be encrypted.

The exemplary banking computing system also includes components located at a bank branch 12. The exemplary bank branch 12 is physically remote from the exemplary data center 10. The exemplary banking computing system includes a teller computing device in the form of a desktop computer 14. Teller computing devices include one or more processors. Bank customers can come to a teller utilizing the desktop computer 14 to conduct a banking transaction. The exemplary banking computing system also includes a teller computing device in the form of a tablet computer 16. A teller utilizing the tablet computer 16 can come to bank customers as they enter the bank branch 12 to conduct banking transactions for the customers.

The exemplary banking computing system also includes a branch server 18. The exemplary branch server 18 is a computing device including one or more processors. The branch server 18 can be local, positioned at the bank branch 12. In one or more other embodiments of the present disclosure, the branch server 18 can be physically remote from the bank branch 12. The branch server 18 can be configured to assist any business entity that fits the network requirements of the bank regarding performance, availability and logical structure. For example, a peripheral control server utilized in one or more embodiments of the present disclosure can handle (may be assigned to) a single workplace, a couple of workplaces, a complete branch or even multiple branches. The exemplary teller computing devices 14, 16 can communicate with the exemplary branch server 18 over a local network within the bank branch 12. Alternatively, if the branch server 18 is physically remote from the bank branch 12, the teller computing devices 14, 16 can communicate with the exemplary branch server 18 over a wide area network. Communications between the branch server 18 and the teller computing devices 14, 16 are secured and can be encrypted.

In one exemplary operation, data associated with a desired financial transaction can be input to the banking computing system through one of the teller computing devices 14, 16. The data can include the name of a banking customer, an account number against which the transaction will apply, a personal identification number, and/or other data. The data associated with the desired financial transaction can then be communicated by the particular teller computing device 14 or 16 to the branch server 18. The data associated with the desired financial transaction can then be communicated by the branch server 18 to the data center 10. The branch server 18 and the data center 10 can communicate with one another over one or more private networks, one or more public networks, or a combination of at least one private network and at least one public network. Communications between the branch server 18 and the data center 10 are secured and can be encrypted. The data center 10 can apply business logic 26 to the data associated with the desired financial transaction and determine if the desired financial transaction is approved or rejected. The determination of the application of the business logic 26 can communicated from the data center 10, to the branch server 18, and to the teller computing device 14 or 16 at which the transaction originated.

The exemplary banking computing system also includes a plurality of peripherals located at the bank branch 12. In FIG. 1, peripherals are shown in the form of a magnetic strip card reader 20, a currency recycler/dispenser 22, and a printer 24. It is noted that the peripherals 20, 22, 24 are exemplary and not inclusive; embodiments of the present disclosure can include additional peripherals such as a chip card reader, a signature pad, a display, a pin pad, an alarm device, a device to input text, a depository unit, and/or a check reader/scanner. Each of the exemplary peripherals 20, 22, 24 communicate with the exemplary branch server 18 over the local network within the bank branch 12. Communications between the branch server 18 and each of the peripherals 20, 22, 24 are secured and can be encrypted.

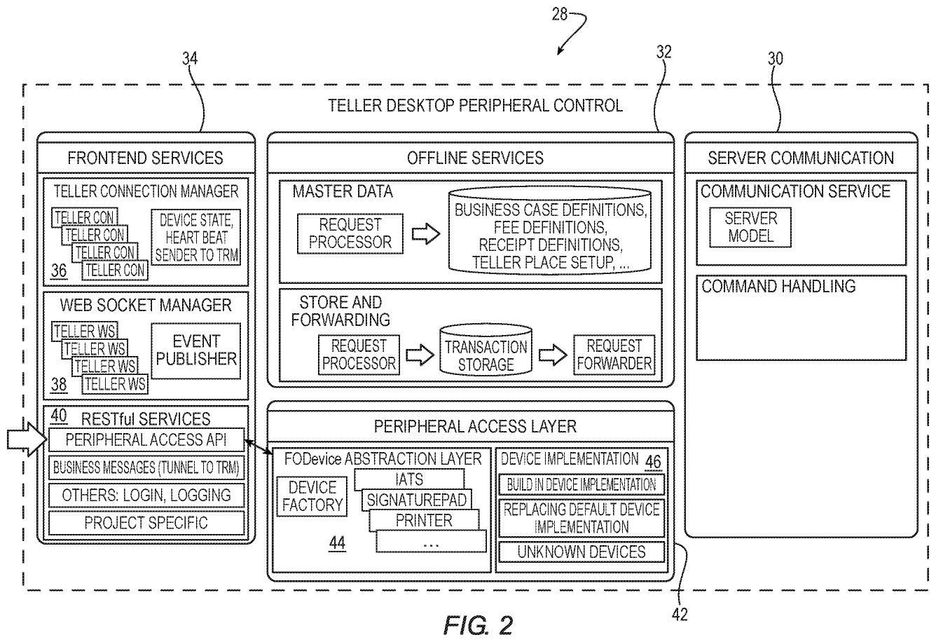

In the exemplary embodiment, the teller computing devices 14, 16 communicate with each of the plurality of peripherals 20, 22, 24 through the branch server 18. Referring now to FIG. 2, a Teller Desktop Peripheral Control Module 28 operates on the bank server 18. The Teller Desktop Peripheral Control Module 28 can be implemented by hardware, software, or a combination of hardware and software. It is noted that the term “Desktop” as used in the term “Teller Desktop Peripheral Control Module” should not be construed to mean that the Teller Desktop Peripheral Control Module 28 is only utilized with desktop computing devices such as the teller computing device 14. The exemplary Teller Desktop Peripheral Control Module 28 is configured to be utilized with any teller-operated computing device, including both teller computing devices 14 and 16.

In one or more embodiments of the present disclosure, the exemplary Teller Desktop Peripheral Control Module 28 can implement/utilize any one or more of the following web technologies: HTML; Cascading Style Sheets (CSS); Syntactically Awesome Stylesheets (SASS) as a preprocessor for CSS; Angular cross-platform Web framework; TypeScript which is a superset of JavaScript, provides type checking and classes, and compiles to plain JavaScript; and/or PrimeNG & Ultima. PrimeNG is a sibling of Primefaces for Angular and includes more than eighty user-interface components. Ultima provides a professional theme for PrimeNG.

In the basic architecture of Angular, a “module” (distinct from the modules and sub-modules discussed above and below) is a block of code that encapsulates a dedicated functionality and contains one or more components. An Angular application has at least one root module and many feature modules. The root module imports all dependent modules needed for the application. A “component” in Angular is a class which caters as the controller for the template (view). The component class interacts with the view through methods and properties. Thus, the template is the view of the component and looks like normal HTML. “Services” in Angular is a class which offers functionality that can be used across the application.

The exemplary Teller Desktop Peripheral Control Module 28 includes a Server Communication Sub-Module 30. The exemplary Server Communication Sub-Module 30 coordinates and controls communications between the Teller Desktop Peripheral Control Module 28 and the data center 10. The exemplary Teller Desktop Peripheral Control Module 28 also includes an Offline Services Sub-Module 32. The exemplary Offline Services Sub-Module 32 stores data utilized by the bank branch 12 and can performed additional functions.

The exemplary Teller Desktop Peripheral Control Module 28 also includes a Frontend Services Sub-Module 34. The exemplary Frontend Services Sub-Module 34 directly engages and communicates with the teller computing devices 14, 16. The exemplary Frontend Services Sub-Module 34 includes a Teller Connection Manager Utility 36, a Web Socket Manager Utility 38, and a RESTful Services Interface 40. The exemplary Frontend Services Sub-Module 34 is configured to establish secure connections with the teller-utilized computing devices 14, 16 and permit the teller-utilized computing devices 14, 16 to exercise control over the peripherals 20, 22, 24 with HTTPS. The exemplary Frontend Services Sub-Module 34 is also configured to provide protection against Cross-Site Request Forgery (XSRF) and protection against Cross-Site Scripting (XSS).

In order to secure connections between the Angular application implemented by the browsers of the teller-utilized computing devices 14, 16 and the exemplary Frontend Services Sub-Module 34, with HTTPS, in the exemplary embodiment, the teller-utilized computing devices 14, 16 are only visible on an Intranet (the network within the branch), not visible on a public network such as the Internet. Since official Certification Authorities (CA) do not issue certificates for non-public hosts, in the exemplary embodiment the branch server 18 will create a CA root certificate and also create a server certificate that is signed by the CA root certificate.

The exemplary Teller Desktop Peripheral Control Module 28 also includes a peripheral interface in the form of a Peripheral Access Layer 42. The exemplary Peripheral Access Layer 42 directly engages and communicates with the RESTful Services Interface 40 and also with the peripherals 20, 22, 24. The exemplary Peripheral Access Layer 42 is disposed between the RESTful Services Interface 40 and the peripherals 20, 22, 24 and facilitates communication between the RESTful Services Interface 40 and each of the peripherals 20, 22, 24. The exemplary Peripheral Access Layer 42 includes an FODevice Abstraction Layer 44 and a Device Implementation Sub-module 46.

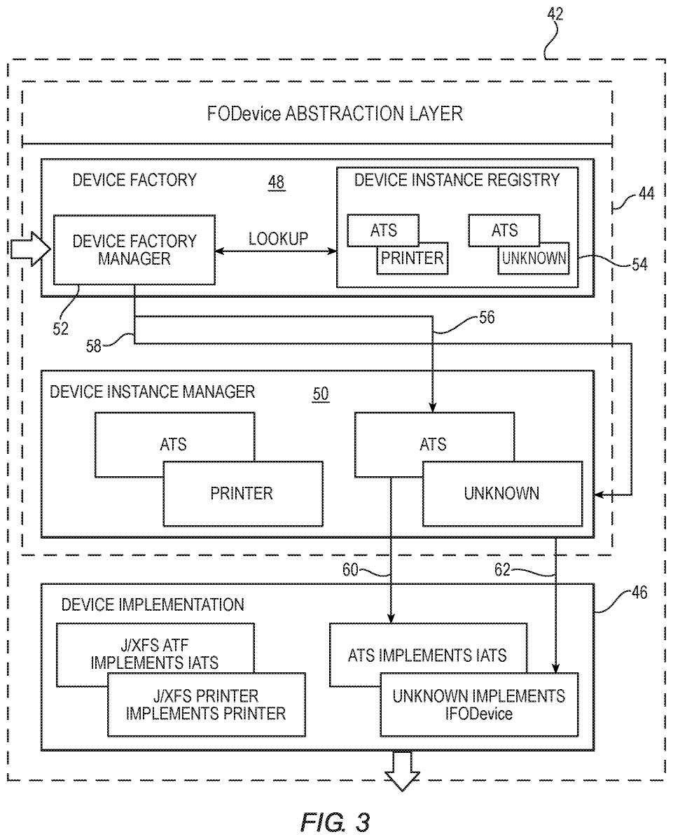

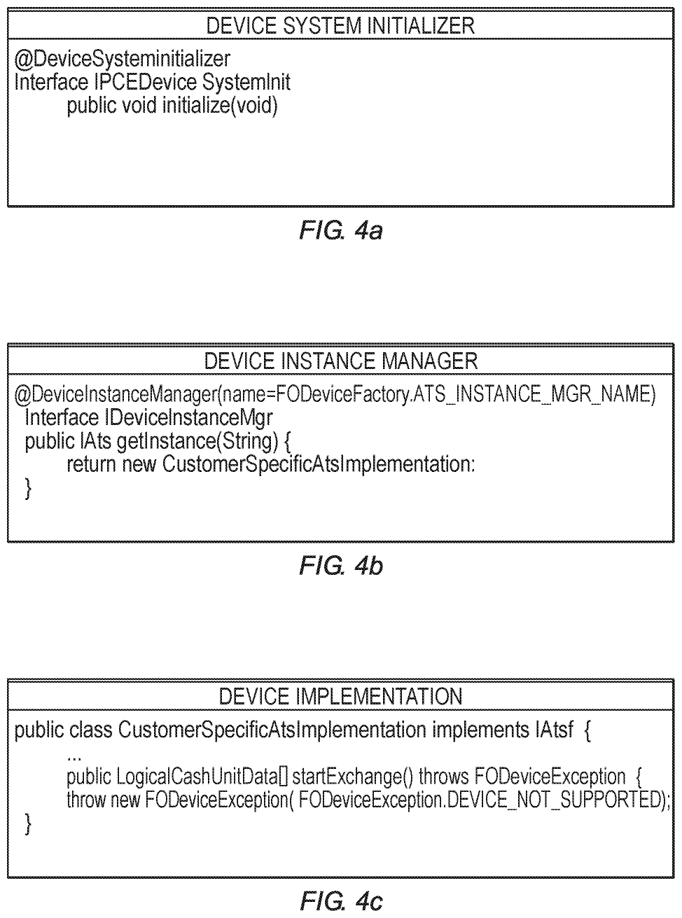

Referring now to FIG. 3, the exemplary FODevice Abstraction Layer 44 includes a Device Factory Sub-module 48 and a Device Instance Manager Sub-module 50. The exemplary Device Factory Sub-module 48 receives input from the exemplary RESTful Services Interface 40, which had received the input from one of the teller-utilized computing devices 14, 16. Such inputs can include a request to identify available peripherals or a request for a particular peripheral to execute a particular task. The input can be received by a Device Factory Manager portion 52 of the exemplary Device Factory Sub-module 48. In response to receiving the input, the Device Factory Manager portion 52 can access a Device Instance Registry portion 54 of the exemplary Device Factory Sub-module 48. The exemplary Device Instance Registry portion 54 stores a listing of all peripherals at the bank branch 12. The exemplary Device Instance Registry portion 54 can access an extension file in the memory of the branch server 18 to populate the registry. It is noted that the extension file itself is not a “real” file. During application startup the supplied libraries are scanned for implementations of device instance managers. The results are compiled to a list and sorted by priority. Upon access the device factory selects an appropriate instance manager and instructs it to create a device implementation. The data in this extension file directory can be modified, for example if a peripheral is modified or eliminated. The data in this extension file directory can be supplemented or expanded, for example if a peripheral is added to the bank branch 12. FIG. 4a is exemplary code executed during startup of the Teller Desktop Peripheral Control Module 28; all classes annotated with @DeviceSystemInitializer are called to execute any needed initializations for peripherals in the bank branch 12.

Referring again to FIG. 3, when the input received by the exemplary Device Factory Sub-module 48 is a request for a particular peripheral to execute a particular task, the exemplary Device Factory Sub-module 48 can direct the request to the exemplary Device Instance Manager Sub-module 50. A communication to initialize a cash dispenser (designated as “ATS”), from the exemplary Device Factory Sub-module 48 to the exemplary Device Instance Manager Sub-module 50, is referenced at 56. A communication to initialize a newly-added peripheral device (designated as “unknown”), from the exemplary Device Factory Sub-module 48 to the exemplary Device Instance Manager Sub-module 50, is referenced at 58.

In response to receipt of the communication, the Device Instance Manager Sub-module 50 creates an instance and communicates the instance to the appropriate peripheral. The instance corresponds to the request for the particular peripheral to perform the particular task. A communication of an instance the ATS, from the exemplary Device Instance Manager Sub-module 50 to the exemplary Device Implementation Sub-module 46, is referenced at 60. A communication to initialize a newly-added peripheral device (designated as “unknown”), from the exemplary Device Instance Manager Sub-module 50 to the exemplary Device Implementation Sub-module 46, is referenced at 62.

FIG. 4b shows exemplary code executed by the exemplary Device Instance Manager Sub-module 50 to create an instance. During the device lookup by the Device Factory Manager portion 52, the needed Device Instance Manger (represented by the boxes within the Device Instance Manager Sub-module 50 in FIG. 3) is identified by the name given in annotation @DeviceInstanceManager. The FODevice Abstraction Layer 44 provides for all builds in the Device Instance Manager name-defines.

Referring again to FIG. 3, the exemplary Device Implementation Sub-module 46 receives instances from the exemplary Device Instance Manager Sub-module 50 and calls the appropriate code to send to the particular peripheral that is to execute the requested task. FIG. 4c shows an exemplary class declaration for an object implemented in the exemplary Device Implementation Sub-module 46 receiving requests from the exemplary Device Instance Manager Sub-module 50. Hardware access is implemented in a custom class created by the corresponding device manager (represented by the boxes within the Device Implementation Sub-module 46 in FIG. 3). Implementations are throwing FODeviceExceptions in case of operation failures or device errors. The exemplary Device Implementation Sub-module 46 then transmits the appropriate code to the particular peripheral and that peripheral executes the requested task.

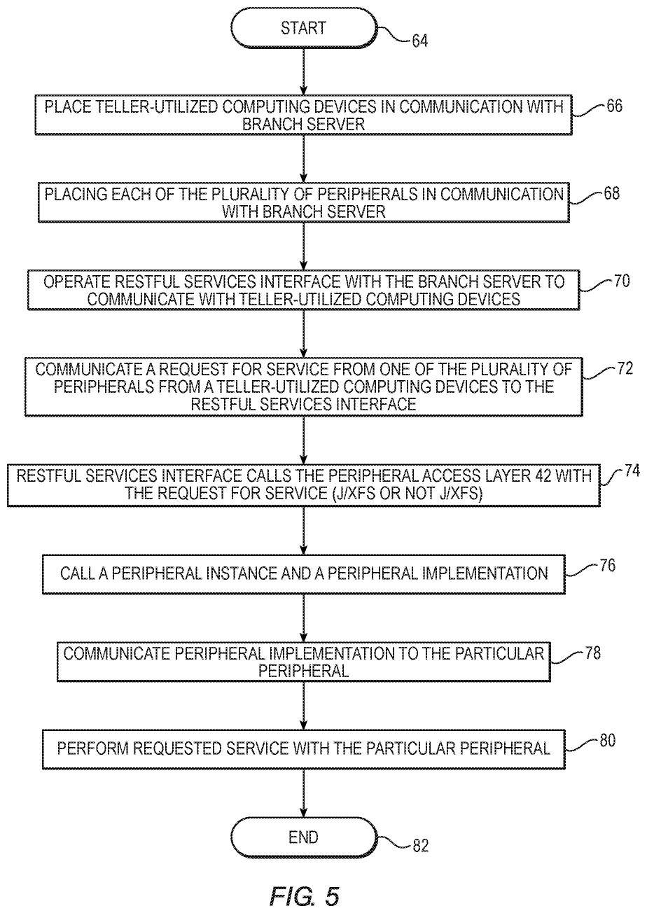

FIG. 5 is a flow chart illustrating a method that can be carried out in one or more embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The method illustrated in FIG. 5 is a method of interconnecting, within the bank branch 12, a teller-utilized computing device 14, 16 with a plurality of peripherals 20, 22, 24. The method starts at step 64. At step 66, the teller-utilized computing device 14, 16 are placed in communication with the branch server 18 of the bank branch 12. For example, the teller-utilized computing device 14, 16 and the branch server 18 can be placed in communication with one another over a hard-wired network, a wireless network, or a network that is partially hard-wired and partially wireless. The teller-utilized computing device 14, 16 and the branch server 18 are placed in communication with one another so that data can be transmitted between the teller-utilized computing device 14, 16 and the branch server 18.

At step 68, each of the plurality of peripherals 20, 22, 24 is placed in communication with the branch server 18 of the bank branch 12. For example, the peripherals 20, 22, 24 and the branch server 18 can be placed in communication with one another over a hard-wired network, a wireless network, or a network that is partially hard-wired and partially wireless. The peripherals 20, 22, 24 and the branch server 18 are placed in communication with one another so that data can be transmitted between the peripherals 20, 22, 24 and the branch server 18.

At step 70, the branch server 18, operates the RESTful Services Interface 40. The RESTful Services Interface 40 allows the computing devices 14, 16 to access the peripherals 20, 22, 24 via http/https. The RESTful Services Interface 40 defines a much higher level of abstraction than a J/XFS interface. This makes the implementation of new peripherals, which are accessed in a Web App, much easier.

At step 72, one of the teller-utilized computing devices 14, 16 communicates a request for service from one of the plurality of peripherals 20, 22, 24 to the RESTful Services Interface 40 through a browser operating on the teller-utilized computing device 14, 16 and via http/https. An exemplary request for service can be a print job to a peripheral in the form of the currency recycler/dispenser 22. Another exemplary request for service can be to intake the data from the magnetic strip of a card to a peripheral in the form of the magnetic strip card reader 20. Another exemplary request for service can be to dispense an amount of currency from a peripheral in the form of the printer 24.

At step 74, the RESTful Services Interface 40 calls a peripheral interface in response to receiving the request for service. In the exemplary embodiment, the peripheral interface is the Peripheral Access Layer 42 and defines an abstraction layer that is independent of J/XFS. So peripherals may utilize J/XFS and other may not; the Peripheral Access Layer 42 can access both kinds of peripherals and is thus independent of J/XFS (not dependent on J/XFS). The request for service is communicated to the Peripheral Access Layer 42 during the calling.

At step 76, the Device Instance Manager Sub-module 50 of the Peripheral Access Layer 42 calls a peripheral instance corresponding to the one of the plurality of peripherals 20, 22, 24 and the Device Implementation Sub-module 46 of the Peripheral Access Layer 42 calls a peripheral implementation corresponding to the peripheral instance. In one example, the Device Instance Manager Sub-module 50 calls code as shown in FIG. 4b, generates an instance based on that code, and directs the instance to the Device Implementation Sub-module 46. In response to receiving the instance, the Device Implementation Sub-module 46 calls code as shown in FIG. 4c to determine instructions (the peripheral implementation) for the particular peripheral that is to execute the task. The peripheral implementation includes a command to perform the service requested during the communicating at step 72. The peripheral implementation may be in J/XFS format or may not be in J/XFS format.

At step 78, the Device Implementation Sub-module 46 of the Peripheral Access Layer 42 communicates the peripheral implementation (command instructions for executing the task) to the particular peripheral of the plurality of peripherals 20, 22, 24 that will perform the desired task. At step 80, that peripheral performs the requested service. The exemplary method ends at step 82.

As set forth above, the exemplary embodiment simplifies the addition of new peripherals to the bank branch 12, especially peripherals that do not provide a J/XFS implementation. As also set forth above, the exemplary Device Instance Registry portion 54 can access an extension file in the memory of the branch server 18 to populate the registry. The data in this extension file directory can be supplemented or expanded, for example if a peripheral is added to the bank branch 12. The operator of the bank branch can introduce a new peripheral by creating a “Class Declaration” and a “Method declaration/implementation” and saving these files in the extension file if, as mentioned above, the provided declaration and implementation does not need to be supplied in a file. It is sufficient, to pack the desired files into a library archive, available to the application. It is then scanned during startup and all necessary information is stored internally.

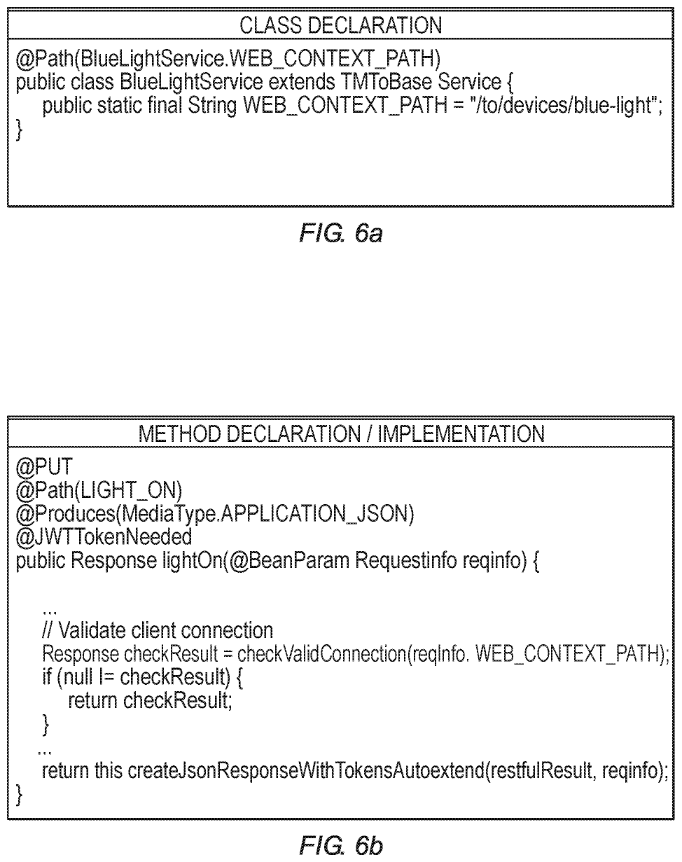

FIG. 6a is exemplary code of a Class Declaration. The exemplary code applies JAX-RS annotations in order to expose a JAVA class and its methods as RESTful services. The notation “TMToBaseService” visible in FIG. 6a provides utility methods to build the JSON response, to check if the client who requested the service has a valid client connection, and to manage the Java Web Token (JWT). FIG. 6b is exemplary code of a Method declaration/implementation. The annotation “JWTTokenNeeded” visible in FIG. 6b is provided by the smart pc implementation and ensures that this RESTful services is just called if the JWT is present and if the given CSRF-Token is valid.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein is hereby unconditionally reserved. The use of the word “can” in this document is not an assertion that the subject preceding the word is unimportant or unnecessary or “not critical” relative to anything else in this document. The word “can” is used herein in a positive and affirming sense and no other motive should be presumed. More than one “invention” may be disclosed in the present disclosure; an “invention” is defined by the content of a patent claim and not by the content of a detailed description of an embodiment of an invention.

What is claimed is:

1. A method of interconnecting, within a bank branch, a teller-utilized computing device with a plurality of peripherals comprising:
placing the teller-utilized computing device in communication with a branch server of the bank branch;
placing each of the plurality of peripherals in communication with the branch server of the bank branch;
operating, on the branch server, a RESTful Services Interface;
communicating, by the teller-utilized computing device, a request for service from one of the plurality of peripherals to the RESTful Services Interface through a browser operating on the teller-utilized computing device;
calling, with the RESTful Services Interface, a peripheral interface in response to receiving the request for service, wherein the peripheral interface defines an abstraction layer that is independent of J/XFS, and wherein the request for service is communicated to the peripheral interface during said calling;
calling, with the peripheral interface, a peripheral instance corresponding to the one of the plurality of peripherals and a peripheral implementation corresponding to the peripheral instance, the peripheral implementation including a command to perform the service requested during said communicating;
communicating, from the peripheral interface, the peripheral implementation to the one of the plurality of peripherals; and
performing, with the one of the plurality of peripherals, the requested service.

2. The method of claim 1 wherein said calling the peripheral instance is further defined as:
calling, with the peripheral interface, the peripheral instance corresponding to the one of the plurality of peripherals and the peripheral implementation corresponding to the peripheral instance, the peripheral implementation including the command to perform the service requested during said communicating, the command not using J/XFS specified interfaces.

3. The method of claim 1 wherein said calling the peripheral instance is further defined as:
calling, with the peripheral interface, the peripheral instance corresponding to the one of the plurality of peripherals and the peripheral implementation corresponding to the peripheral instance, the peripheral implementation including the command to perform the service requested during said communicating, the command using J/XFS specified interfaces.

4. The method of claim 3 further comprising:
communicating, by the teller-utilized computing device, a second request for service from a second peripheral of the plurality of peripherals to the RESTful Services Interface through the browser operating on the teller-utilized computing device;
calling, with the RESTful Services Interface, the peripheral interface in response to receiving the second request for service, wherein the second request for service is communicated to the peripheral interface during said calling the peripheral interface in response to receiving the second request for service;
calling, with the peripheral interface, a second peripheral instance corresponding to the second peripheral of the plurality of peripherals and a peripheral implementation corresponding to the second peripheral instance, the second peripheral implementation including a second command to perform the service requested during said communicating the second request for service, the second command not being in J/XFS format;
communicating, from the peripheral interface, the second peripheral implementation to the second peripheral of the plurality of peripherals; and
performing, with the second peripheral of the plurality of peripherals, the service requested during said communicating the second request for service.
